(19) United States
(12) Patent Application Publication
(10) Pub. No.: US 2006/0085822 A1
(43) Pub. Date: Apr. 20, 2006

(54) TV server cluster system

(75) Inventors: Chiao-Yung Chang, Chung Ho City (TW); Manu Chen, Chung Ho City (TW); Jiun-Kuei Jung, Chung Ho City (TW)

Correspondence Address: BIRCH STEWART KOLASCH & BIRCH, PO BOX 747, FALLS CHURCH, VA, 22040-0747, US

(73) Assignee: AverMedia TECHNOLOGIES, INC.

(21) Appl. No.: 11/080,465

(22) Filed: Mar. 16, 2005

(30) Foreign Application Priority Data
Oct. 14, 2004 (TW) 93131195

(51) Int. Cl. H04N 7/18

(52) U.S. Cl. 725/80; 725/74; 725/78

(57) ABSTRACT

The present invention provides a television (TV) server cluster system including a plurality of TV servers. A TV server is negotiated from these TV servers to be a cluster server. Any end user can issue channel requirements or channel switching requirements to the cluster server through the Internet system. Then, the required channel information is transferred to a corresponding end user.

### RELATED APPLICATIONS

The present application is based on, and claims priority from, Taiwan Application Serial Number 93131195, filed on Oct. 14, 2004, the disclosure of which is hereby incorporated by reference herein in its entirety.

### FIELD OF THE INVENTION

The present invention relates to a cluster system, and more particularly to a TV server cluster system.

### BACKGROUND OF THE INVENTION

Television has served as an audio and video information supplier for a long time. People can obtain weather predictions, the latest news, entertainment information and so on from television.

Today, television is no longer the only display apparatus. For example, the display of a computer also can be used to display the audio and video (AV) signal of a television after installing an audio and video transfer apparatus in the computer.

However, typically, each display requires an audio and video transfer apparatus for transferring the AV signal. In other words, the typical audio and video transfer apparatus does not have a common function for use on multiple displays. Additionally, there is no communication channel between any two audio and video transfer apparatuses. Therefore, even though two displays are to show the same channel information, two audio and video transfer apparatuses are required. Such a requirement increases the usage cost.

### SUMMARY OF THE INVENTION

Therefore, it is the main object of the present invention to provide a television server cluster system wherein servers can communicate to each other through an Internet system.

Another purpose of the present invention is to provide a television server cluster system wherein servers can share sources with each other through an Internet system.

Yet another purpose of the present invention is to provide a television server cluster system that can arrange channel information through the Internet system.

A further purpose of the present invention is to provide a method to arrange channel information through the Internet.

A further purpose of the present invention is to provide a channel information arrangement method.

Accordingly, the present invention provides a television (TV) server cluster system including a plurality of TV servers. A TV server is negotiated from these TV servers to be a cluster server. Any end user can issue channel requirements or channel switching requirements to the cluster server through the Internet system. Then, the required channel information is transferred to the corresponding end user.

The cluster server can integrate the channel arrangement. After the cluster server receives a channel requirement from a user, it first checks whether or not the required channel information is provided by a TV server. If a TV server is providing the required channel to another end user, the cluster server orders this TV server to open the channel information to the end user issuing the channel requirement. Otherwise, an idle TV server is arranged by the cluster server to provide the required channel information to the end user. A channel information shared destination can be achieved by this system of the present invention.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1 is a schematic diagram of a TV server cluster system according to the preferred embodiment of the present invention;

FIG. 2 is a schematic diagram of a TV server according to the preferred embodiment of the present invention;

FIG. 3 is a schematic diagram of a cluster server according to the preferred embodiment of the present invention;

FIG. 4 is a schematic diagram of an end user according to the preferred embodiment of the present invention; and

FIG. 5 illustrates an operation flow chart of the TV server cluster system according to the preferred embodiment of the present invention.

### DETAILED DESCRIPTION OF THE PREFERRED EMBODIMENT

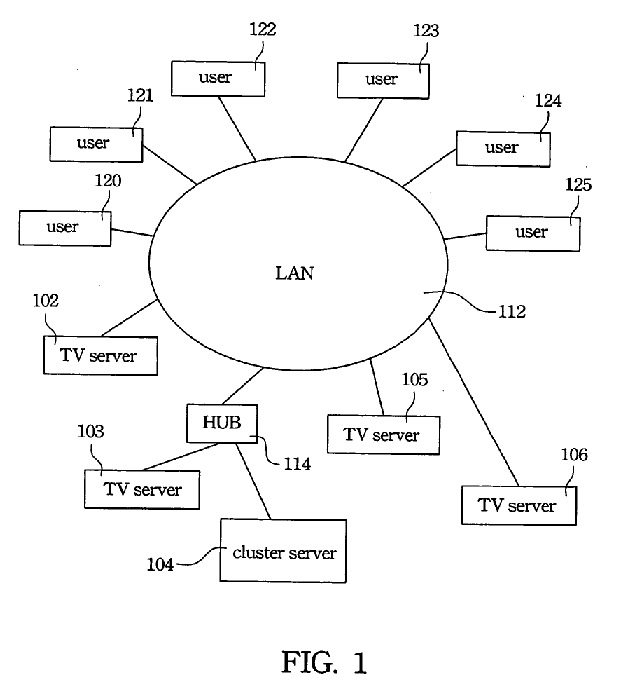

FIG. 1 illustrates a schematic diagram of a TV server cluster system according to the preferred embodiment of the present invention. According to this system, many television (TV) servers 102 to 106 are connected directly or through a hub 114 to a local area network (LAN) 112. Many end users 120 to 125 with displays are also connected to the LAN 112 through their network connectors, respectively. Each end user may issue a channel requirement to a cluster server (described in the following) through the LAN 112. Then, the cluster server may arrange one of the TV servers 102 to 106 to provide the required channel information to the end user.

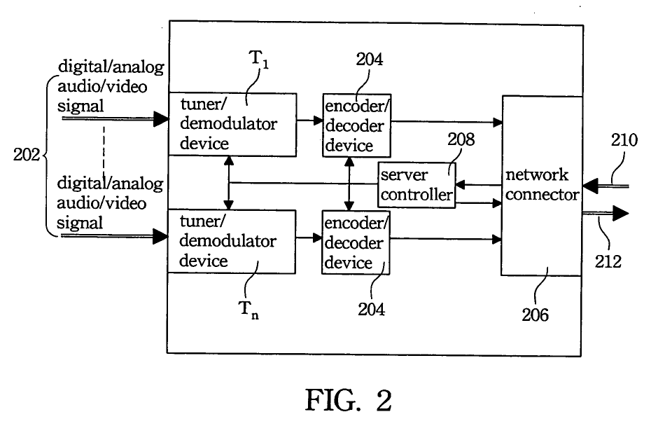

Each TV server 102 to 106 is an apparatus that may be connected to the Internet and receive audio-video signals for a TV. FIG. 2 is a schematic diagram of a TV server according to the preferred embodiment of the present invention. Each TV server includes many Tuner/Demodulator devices T₁ to Tₙ. Each Tuner/Demodulator device may receive a digital/analog audio-video signal 202 sent from a cable. This received digital/analog audio-video signal 202 is decoded and decompressed by an encoder/decoder device 204. Then, the processed audio-video signal is sent to the LAN 112 through a network connector 206. In other words, the Tuner/Demodulator devices may collect corresponding audio-video signals and convert said corresponding audio-video signals into a standard signal for display by a display apparatus.

The digital/analog audio-video signal 202 transferred in a cable is shared among Tuner/Demodulator devices T₁ to Tₙ. A server controller 208 orders one of the Tuner/Demodulator devices T₁ to Tₙ to collect special channel information based on the received channel requirement. It is noticed that there can be more than one connected cable. In other words, the digital/analog audio-video signal 202 may be from more than one cable. The network connector 206 can be a wired or a wireless connector. This connector 206 is used to receive the channel requirement from a cluster server and send the required channel information 212 to an end user.

Cluster server functionality exists in some of the TV servers 102 to 106. A cluster server is negotiated from these TV servers with the cluster server function. This cluster server is used as a communication center for end users. In other words, an end user can communicate with any TV server through the cluster server. It is noticed that only one TV server can act the cluster server at the same time. However, the negotiation work of determining which TV server to act as the cluster server can be processd at any time. In other words, the cluster server can be dynamically determined based on the end user usage condition. When an end user issues a channel requirement, it is not necessary for the end user to know the exact address of the TV server. The only work for the end user is to send the channel requirement to the cluster server. After receiving the requirement, the cluster server, based on the TV server condition, orders one of the TV servers to respond to the channel requirement. Finally, the required channel information is sent to the end user through the cluster server.

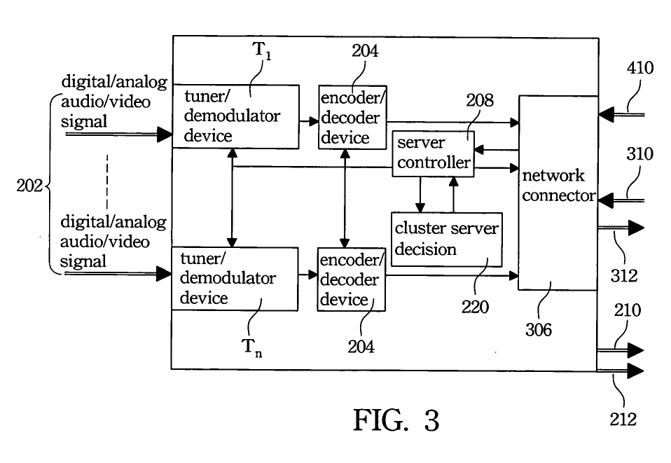

FIG. 3 is a schematic diagram of a cluster server according to the preferred embodiment of the present invention. Compared to a TV server in FIG. 2, an additional cluster server decision 220 is installed in a cluster server for negotiating to act as a cluster server. Therefore, this cluster server illustrated in FIG. 3 also can be used as a TV server. However, it is noticed that a cluster server without the TV server function also can be used in the present invention. The network connector 306 can be a wired or a wireless connector. When negotiating, a negotiation signal 312 is sent out and a negotiation result signal 310 is received by the network connector 306.

If a TV server is negotiated to act as a cluster server, the network connector 306 receives a channel requirement 410 from an end user. After receiving the requirement, the cluster server, based on the TV server condition, sends a channel requirement 210 to one of the TV servers. It is noticed that the cluster server may first check whether or not a TV server is providing the required channel information. If a TV server is providing the required channel to another end user, the cluster server may send the channel requirement 210 to this TV server in order to open the channel information to the end user issuing the channel requirement. On the other hand, if there is no TV server providing the required channel, the cluster server may send the channel requirement 210 to an idle TV server to provide the channel information to the end user issuing the channel requirement.

It is noticed that if the quantity of required channel information is more than the capacity of the channel information, the end user that last issues a channel requirement can only select the channel information that has been provided. On the other hand, because the cluster server has TV server functionality in the present invention, the network connector 306 can also send required channel information to an end user. Additionally, a new TV server or new analog/digital AV signal can be included into the system at any time and be arranged by the cluster server.

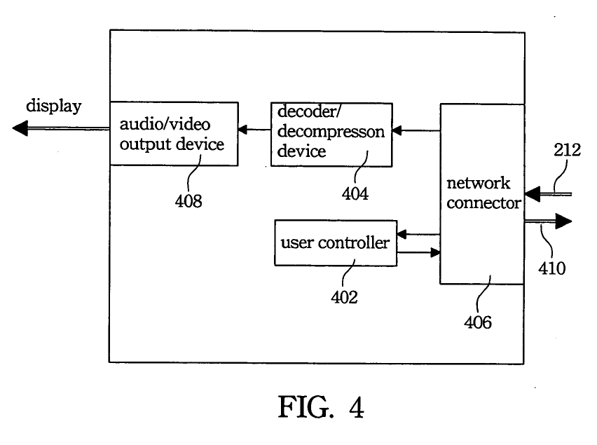

FIG. 4 is a schematic diagram of an end user according to the preferred embodiment of the present invention. This end user includes a network connector 406, a user controller 402 that can issue a channel requirement, a decoder/decompressor device 404 and an audio-video output device 408. The network connector 406 can send out a channel requirement issued by the user controller and receive an AV signal. This AV signal is decoded and decompressed by the decoder/decompressor device 404. The processed AV signal is then sent to a display. The network connector 406 can be a wired or a wireless connector for sending a channel requirement 410 and receiving required channel information 212 from a cluster server. The display at an end user is a liquid crystal display (LCD), a CRT display, a PDP television or an LCD television.

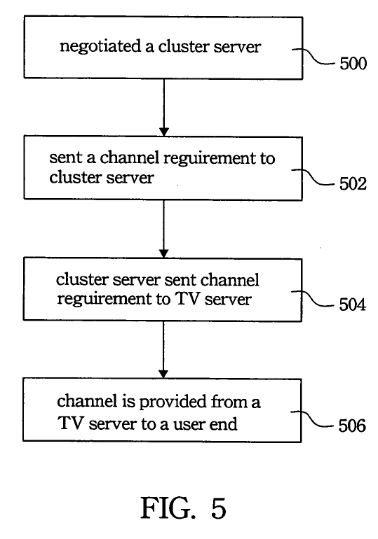

FIG. 5 illustrates an operation flow chart of the TV server cluster system according to the preferred embodiment of the present invention, also referring to FIGS. 2 through 4. First, in step 500, TV servers with cluster server functionality may send out negotiation signals 312 from their connectors 406 to negotiate a TV server to act as a cluster server. After a TV server is selected to act as the cluster server, the negotiation result signal 310 is sent to each TV server to tell them the negotiation result. According to the present invention, the TV server 104 is selected to act as the cluster server.

Next, in step 502, an end user, such as end user 122, issues a channel requirement 410 from its connector 406 to the cluster server, TV server 104, through the LAN 112. In step 504, after the cluster server 104 receives the channel requirement 410, it first checks whether or not the required channel information is provided by a TV server. If a TV server is providing the required channel to another end user, the cluster server 104 sends the channel requirement 210 to this TV server in order to open the channel information to the end user. If there is no TV server providing the required channel, the cluster server 104 may send the channel requirement 210 to an idle TV server to provide the channel information to the end user. Finally, in step 506, after a TV server receives the channel requirement 210 from the cluster server 104, the required channel information is sent to the end user 122 that issues the channel requirement.

Accordingly, the TV server cluster system of the present invention has a cluster server. Any end user can issue a channel requirement or channel switching requirements to this cluster server through an Internet system. Then, the required channel information is transferred to a corresponding end user. In other words, this cluster server can integrate the channel arrangement. When end users issue a same channel requirement to this cluster server, this cluster server can arrange a TV server to supply this channel to those end users. Therefore, the system of this present invention can attain the goal of sharing the TV server and reducing the cost of constructing the TV server. When a channel switching requirement is issued and the required channel has been supplied by a TV server, this cluster server orders this TV server to open this channel information to this required end user. Getting the required channel information from a cable again is not necessary. In such a method, many audio-video transforming processes are eliminated. Therefore, this method can improve the channel switching efficiency.

As is understood by a person skilled in the art, the foregoing descriptions of the preferred embodiment of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While a preferred embodiment of the invention has been illustrated and described, it will be appreciated that various changes can be made therein without departing from the spirit and scope of the invention.

What is claimed is:

1. A television server cluster system, wherein said system is connected to a local area network to arrange channel information to at least one end user, said system comprising:
a plurality of TV servers respectively connected to said local area network, wherein one of said TV servers is a cluster server to receive a channel requirement from said at least one end user and said cluster server orders one of said TV servers to make a response based on said channel requirement.

2. The system of claim 1, wherein said TV servers are connected to at least one audio-video signal source.

3. The system of claim 2, wherein said TV server comprises a tuner device to collect audio-video signals and convert said audio-video signals into a signal for displaying by a display.

4. The system of claim 3, wherein said display is a liquid crystal display, a CRT display, a PDP television or an LCD television.

5. The system of claim 1, wherein each of said TV server and said end user respectively comprises a connector for connecting to said local area network.

6. The system of claim 1, wherein said connector is a wired or a wireless connector.

7. A television server cluster system, said system comprising:
a local area network;
at least one end user connecting to said local area network; and
a plurality of TV servers respectively connected to said local area network, wherein one of said TV servers is a cluster server to receive a channel requirement from said at least one end user and said cluster server orders one of said TV servers to make a response based on said channel requirement.

8. The system of claim 7, wherein said TV servers are connected to at least one audio-video signal source.

9. The system of claim 8, wherein said TV server comprises a tuner device to collect audio-video signals and convert said audio-video signals into a signal for displaying by a display.

10. The system of claim 7, wherein each of said TV server and said end user respectively comprises a connector for connecting to said Internet.

11. The system of claim 10, wherein said connector is a wired or a wireless connector.

12. A television server cluster system, said system comprising:
a local area network;
at least one end user connecting to said local area network;
a plurality of TV servers respectively connected to said local area network; and
a cluster server to receive a channel requirement from said at least one end user and said cluster server orders one of said TV servers to make a response based on said channel requirement.

13. The system of claim 12, wherein said TV servers are connected to at least one audio-video signal source.

14. The system of claim 13, wherein said TV server comprises a tuner device to collect audio-video signals and convert said audio-video signals into a signal for displaying by a display.

15. The system of claim 12, wherein each of said TV server, said end user and said cluster server respectively comprises a connector for connecting to said Internet.

16. The system of claim 15, wherein said connector is a wired or a wireless connector.

17. A method for arranging channels in a local area network, wherein at least one end user and a plurality of television (TV) servers are respectively connected to said local area network, said method comprising:
negotiating a cluster server from said TV servers;
sending a channel requirement from said at least one end user to said cluster server;
sending an order signal from said cluster server to one of said TV servers, wherein said cluster server selects one TV server to send said order signal based on its usage condition; and
transeferring an audio-video signal from said selected TV server to said end user.

18. The method of claim 19, wherein said selected TV server is an idle TV server.

19. The method of claim 19, wherein said selected TV server is a TV server that is providing a channel the same as said channel requirement.

20. The method of claim 19, wherein said audio-video signal is a signal for displaying by a display.
